(19) United States
(12) Patent Application Publication
(10) Pub. No.: US 2025/0121351 A1
(43) Pub. Date: Apr. 17, 2025

(54) METHOD OF FORMING FLUORITE FROM A FLUORIDE-CONTAINING FLUID USING BIOACTIVE GLASS, AND FILTER MEDIA CONTAINING BIOACTIVE GLASS

(71) Applicant: CORNING INCORPORATED, CORNING, NY (US)

(72) Inventors: Qiang Fu, Painted Post, NY (US); Jerry C. Hou, Oakland, CA (US); Cedrick Alexander O’Shaughnessy, Painted Post, NY (US); Nicholas Michael Stone-Weiss, Corning, NY (US)

(21) Appl. No.: 18/893,022

(22) Filed: Sep. 23, 2024

Related U.S. Application Data
(60) Provisional application No. 63/544,048, filed on Oct. 13, 2023.

(51) Int. Cl. B01J 20/10; B01J 20/28; C02F 1/28; C02F 101/14; C03C 3/062; C03C 3/097; C03C 3/112; C03C 17/22

(52) U.S. Cl. CPC B01J 20/103; B01J 20/28004; B01J 20/28016; C02F 1/281; C03C 3/062; C03C 3/097; C03C 3/112; C03C 17/22; C02F 2101/14; C03C 2217/285; C03C 2218/11

(57) ABSTRACT

A method for forming fluorite from a F⁻-containing aqueous fluid, the method comprising: contacting a bioactive glass comprising calcium with the F⁻-containing aqueous fluid; and forming the fluorite. A filter media, and filter containing the filter media, for forming fluorite from a F⁻-containing aqueous fluid, the filter media comprising: a bioactive glass comprising calcium; and at least one of sand, gravel, charcoal, polymer particles, and ceramic particles.

### CROSS REFERENCE TO RELATED APPLICATIONS

This application claims priority to U.S. Provisional Patent Application No. 63/544,048, filed on Oct. 13, 2023, which is incorporated herein by reference in its entirety for all purposes.

### FIELD

The disclosure relates generally to methods of forming fluorite, and more particularly to methods of forming fluorite from a bioactive glass and a F⁻-containing aqueous fluid, as well as a filter media used for such purpose.

### BACKGROUND

Elevated fluoride content in aqueous environments, such as in drinking water and in the environment, can present significant health risks. Therefore, there is a need in the art for methods, filtration media, and filters useful for capturing fluoride and/or reducing fluoride content in aqueous environments. There is also a need in the art for methods for producing pure forms of fluorite. This disclosure is related to these, as well as other, important ends.

### SUMMARY

The disclosure relates, in various aspects, to a method for forming fluorite from a F⁻-containing aqueous fluid, the method comprising: contacting a bioactive glass comprising calcium with the F⁻-containing aqueous fluid; and forming the fluorite.

The disclosure relates, in various aspects, to a filter media for forming fluorite from a F⁻-containing aqueous fluid, the filter media comprising: a bioactive glass comprising calcium; and at least one of sand, gravel, charcoal, polymer particles, and ceramic particles.

The disclosure relates, in various aspects, to a method for making filter media, comprising combining bioactive glass and at least one of sand, gravel, charcoal, polymer particles, and ceramic particles.

The disclosure relates, in various aspects, to a filter comprising filter media.

The disclosure relates, in various aspects, to a method for making a filter, comprising inserting filter media into a filter body.

Additional features and advantages of the disclosure will be set forth in the detailed description which follows, and in part will be readily apparent to those skilled in the art from that description or recognized by practicing the aspects as described herein, including the detailed description which follows, the claims, as well as the appended drawings.

It is to be understood that both the foregoing general description and the following detailed description are merely exemplary and are intended to provide an overview or framework for understanding the nature and character of the disclosure and claims. The accompanying drawings are included to provide a further understanding of the disclosure and are incorporated into and constitute a part of this specification. The drawings illustrate various aspects of the disclosure and together with the description serve to explain the principles and operations of the various aspects.

### BRIEF DESCRIPTION OF THE DRAWINGS

The following detailed description can be further understood when read in conjunction with the following drawings. Whenever possible, the same reference numerals will be used throughout the drawings to refer to the same or like parts. It is to be understood that the figures are not drawn to scale and the size of each depicted component or the relative size of one component to another is not intended to be limiting.

FIG. 1 is a powder x-ray diffraction (XRD) spectrum depicting fluorite formation for various glasses.

FIG. 2 is an XRD spectrum depicting fluorite formation for a glass at different time periods.

FIG. 3 is a scanning electron microscopy (SEM) image of fluorite formation on an outer surface of glass particles. The SEM parameters are 5.0 kV; 8.4 mm; ×10.0k. The scale bar is 5 μm.

FIG. 4 is a scanning electron microscopy (SEM) image of fluorite formation on an outer surface of glass particles. The SEM parameters are 5.0 kV; 8.4 mm; ×25.0k. The scale bar is 2 μm.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other.

Where a range of numerical values is recited herein, comprising upper and lower values, unless otherwise stated in specific circumstances, the range is intended to include the endpoints thereof, and all integers and fractions within the range. Further, when an amount, concentration, or other value or parameter is given as a range, one or more ranges, or a list of upper values and lower values, this is to be understood as specifically disclosing all ranges formed from any pair of any upper range limit or value and any lower range limit or value, regardless of whether such pairs are separately disclosed.

If the term “about” is used in describing a value or an end-point of a range, the disclosure should be understood to include the specific value or end-point referred to. As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. It is noted that the terms “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass that is “free” or “essentially free” of Al₂O₃ (or any other component) is one in which Al₂O₃ (or any other component) is not actively added or batched into the glass, but may be present in very small amounts as a contaminant (e.g., 500, 400, 300, 200, or 100 ppm or less or).

Herein, glass compositions are expressed in terms of wt. % amounts of particular components included therein on an oxide bases unless otherwise indicated. Any component having more than one oxidation state may be present in a glass composition in any oxidation state. However, concentrations of such component are expressed in terms of the oxide in which such component is at its lowest oxidation state unless otherwise indicated.

As used herein, a glass that is “bioactive” means that it is biologically compatible with bone, teeth, and/or tissue. By way of illustration, in some aspects, “bioactive” in this context refers to (1) the ability to form apatite, brushite, whitlockite, or other bioactive crystalline phases such as hydroxyapatite, fluorapatite, carbonated apatite, or any combination thereof, in a simulated body fluid, such as artificial saliva, according to ASTM F1538-03 (2017), (2) the capability of binding with a desired biological material (e.g., bones, teeth, and/or tissue), and/or (3) the capability of remineralize teeth or bone. Generally, there is also an absence of toxicity or other significant negative effects in a biological environment (e.g., bones, teeth, and/or tissue).

As used herein, “non-glass CaO” means CaO that is not present as a component of glass.

As used herein, the term “substantially” may be utilized herein to represent the inherent degree of uncertainty that may be attributed to any quantitative comparison, value, measurement, or other representation. This term is also utilized herein to represent the degree by which a quantitative representation may vary from a stated reference without resulting in a change in the basic function of the subject matter at issue. Thus, for example, a glass or composition that is “substantially free” of an identified species is one in which that species is not actively added, but may be present in small amounts, e.g., as a contaminant, such as less than 0.5 wt. %, less than 0.1 wt. %, less than 0.01 wt. %, and so forth (e.g., 500, 400, 300, 200, or 100 ppm or less). Additionally, if a species is intentionally added, e.g., to a given composition, such a composition may still be considered to be “substantially free” if that species is present in an amount below any of the aforementioned amounts, which may be specified in context.

As used herein, a “F⁻-containing fluid” is a fluid that contains at least some fluoride ions in solubilized form.

As used herein, “weight” and “mass” are used interchangeably with no difference in meaning intended.

Fluoride ion content in aqueous environments can result in significant oral health issues in areas of the world, especially where it is consistently above 1 ppm in drinking water. In specific, elevated fluoride levels can cause dental fluorosis, a condition which causes stripes or stains on teeth due to chronic exposure with high amounts of fluoride. Fluoride in drinking water results from a combination of pollutant sources (such as steel production and burning of fossil fuels) and from fluorides occurring within minerals in the natural environment. Fluorite (CaF₂), for instance, is a fluoride-rich mineral having 48 wt. % of F that occurs abundantly in the natural environment, making it a significant source of natural fluoride. Fluorite generally forms in the environment by hydrothermal methods, forming in solution by the formula:

$${Ca}^{2 +} ( aq . ) + 2 {F}^{-} ( aq . ) \to {CaF}_{2} ( s ) \qquad ( 1 )$$

Fluoride removal from aqueous systems has previously been achieved using Ca-containing materials such as Ca(OH)₂, CaCO₃, or non-glass CaO by precipitation of fluorite (as in Equation 1) and/or adsorption of fluoride at the glass surface.

However, the bioactive glasses disclosed herein provide a different approach to supply calcium ions to form fluorite from fluoride-containing solutions. The bioactive glasses herein provide significant sources of Ca²⁺ ions, which swiftly precipitate fluorite at their surfaces, such as within 1 day. Generally, the bioactive glasses herein not only contain significant fractions of calcium, but also have strong tendencies to release ionic species when in contact with aqueous environments. In fact, they tend to degrade at a significantly faster rate than do Ca-based minerals, thus highlighting their ability to catalyze fluorite precipitation, for example, in charged surface layers.

Disclosed herein is a method for forming fluorite crystals and/or precipitate at the surface of bioactive glasses through reaction of the glass with an aqueous fluoride source. Bioactive glasses dissolve readily in aqueous solutions, thus releasing ions such as Ca²⁺, and rapidly form fluorite precipitates and/or crystals on their surfaces. The Ca²⁺ may be released at the surface of the glass and/or into the surrounding environment. The bioactive glass herein can thus be used as a method to remove fluoride from water, and, in some aspects, the formed fluorite can be collected and repurposed for its use as a pure (>90 wt. %) raw material. The bioactive glass herein may also be provided in a filter media so as to facilitate the capture of fluoride from solution.

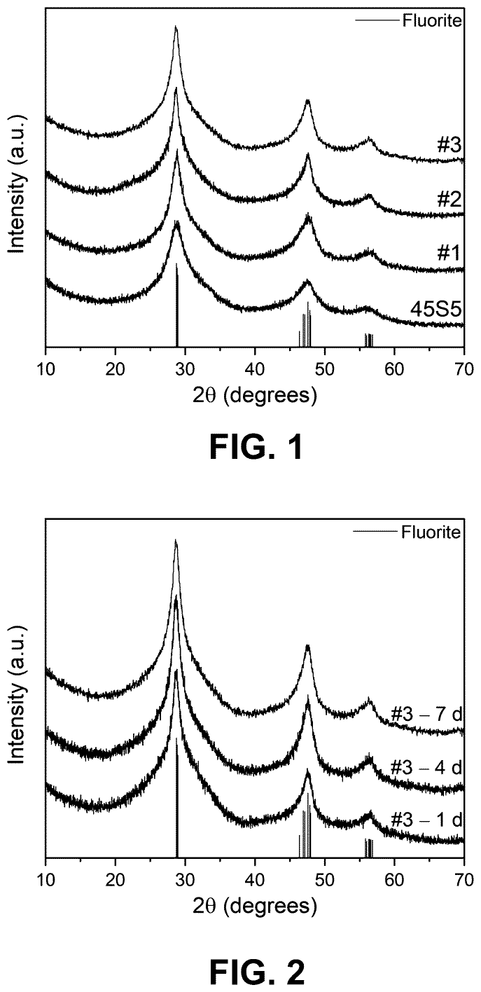

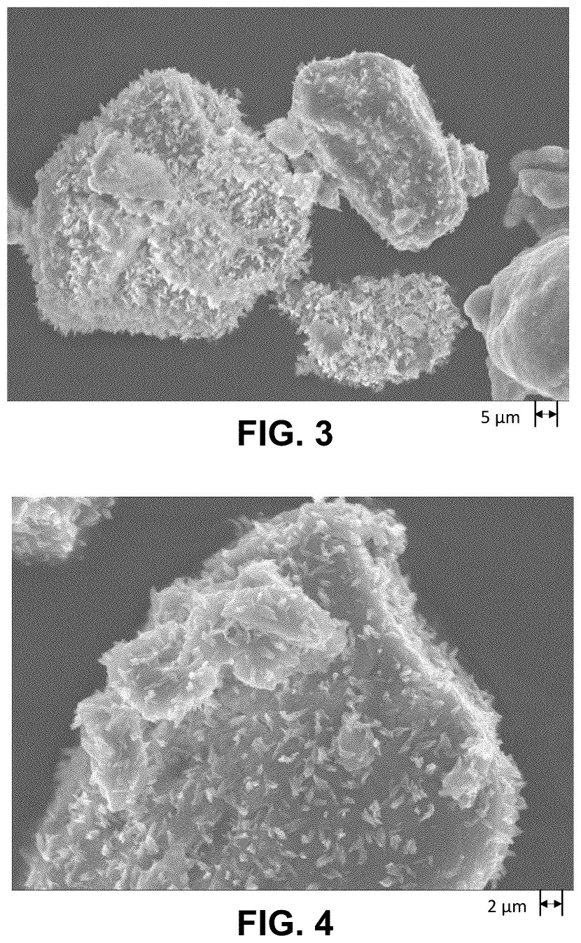

At present, other Ca²⁺ sources such as calcite are utilized to similarly precipitate fluorite in water; however, bioactive glasses can provide the advantage of at least 10× faster calcium release due to their higher solubility in water. Thus, faster fluorite precipitation is expected using the bioactive glasses disclosed herein, which has been observed in the examples herein. For example, fluorite formation by bioactive glass dissolution is shown to occur within 1 day of submersion in fluoride-containing solutions, where the fluorite phase is the only crystalline phase formed within 7 days of glass submersion (FIGS. 1-2). In one aspect, fluorite nanocrystals are present across the glass particle surface after 7 days of solution exposure (FIGS. 3-4).

The bioactive glasses disclosed herein are bioactive and/or biodegradable, making them less concerning for human health than traditional methods, such as those based on calcite.

Disclosed is a method for forming fluorite from a F⁻-containing aqueous fluid, the method comprising: contacting a bioactive glass comprising calcium with the F⁻-containing aqueous fluid; and forming the fluorite.

In some aspects, the F⁻-containing fluid comprises F in any suitable amount. Generally, F is present in the amounts specified herein in solubilized form (e.g., the amount of F generally does not include any F present in solid form, such as solid CaF₂, unless otherwise specified; however, if so desired, the amounts here can be expressed to include solid forms of F). In some aspects, the F⁻-containing fluid comprises F in an amount of at least 1 ppm by mass, based on total mass of the F⁻-containing fluid that is contacted with the bioactive glass. The upper amount is not particularly limited, since the methods and disclosures herein are contemplated to operate at any amount of F; however, in some aspects, the F⁻-containing fluid comprises F in an amount of 20,000 ppm or less, based on total mass of the F⁻-containing fluid that is contacted with the bioactive glass. In some aspects, the F⁻-containing fluid comprises F in an amount (ppm by mass, based on total mass of the F⁻-containing fluid that is contacted with the bioactive glass) of at least 1, at least 2, at least 3, at least 4, at least 5, at least 7, at least 8, at least 9, at least 10, at least 15, at least 20, at least 25, at least 30, at least 35, at least 40, at least 45, at least 50, at least 60, at least 70, at least 80, at least 90, at least 100, at least 150, at least 200, at least 250, at least 300, at least 350, at least 400, at least 450, at least 500, at least 600, at least 700, at least 800, at least 900, at least 1000, at least 1500, at least 2000, at least 2500, at least 3000, at least 3500, at least 4000, at least 4500, at least 5000, at least 6000, at least 7000, at least 8000, at least 9000, at least 10000, at least 15000, or at least 20000. In some aspects, the F⁻-containing fluid comprises F in an amount (ppm by mass, based on total mass of the F⁻-containing fluid that is contacted with the bioactive glass) of 20000 or less, 15000 or less, 10000 or less, 9000 or less, 8000 or less, 7000 or less, 6000 or less, 5000 or less, 4500 or less, 4000 or less, 3500 or less, 3000 or less, 2500 or less, 2000 or less, 1500 or less, 1000 or less, 900 or less, 800 or less, 700 or less, 600 or less, 500 or less, 400 or less, 300 or less, 200 or less, 100 or less, 90 or less, 80 or less, 70 or less, 60 or less, 50 or less, 40 or less, 30 or less, 20 or less, or 10 or less. Any of the aforementioned open-ended ranges can be combined in any manner to form closed ended ranges, such as 1-100, 50-8000, 10000-20000, and so forth.

In some aspects, the method reduces a concentration of the F in the F⁻-containing aqueous fluid to below a specified amount. For example, in some aspects, the specified in amount is an amount that renders the aqueous fluid appropriate for its intended purposes. In some aspects, the intended purpose is for human and/or animal consumption of the aqueous fluid (e.g., as drinking water). In some aspects, the intended purpose is for discharging the aqueous fluid into the environment (e.g., land and/or body of water) from an industrial site. In some aspects, the purpose of the method is to form pure fluorite, in which case the reduction of F in the F⁻-containing aqueous fluid is not a goal but a mere consequence. In any event, in some aspects, the method reduces a concentration (ppm by mass, based on total mass of the F⁻-containing fluid that is contacted with the bioactive glass) of F in the F⁻-containing aqueous fluid to 10000 or less, 9000 or less, 8000 or less, 7000 or less, 6000 or less, 5000 or less, 4000 or less, 3000 or less, 2000 or less, 1000 or less, 900 or less, 800 or less, 700 or less, 600 or less, 500 or less, 400 or less, 300 or less, 200 or less, 100 or less, 50 or less, 40 or less, 30 or less, 20 or less, 10 or less, 5 or less, 4 or less, 3 or less, 2 or less, or 1 or less. In some aspects, the method reduces a concentration (ppm by mass, based on total mass of the F⁻-containing fluid that is contacted with the bioactive glass) of F in the F⁻-containing aqueous fluid to 1 or more, 2 or more, 3 or more, 4 or more, 5 or more, 10 or more, 20 or more, 30 or more, 40 or more, 50 or more, 60 or more, 70 or more, 80 or more, 90 or more, 100 or more, 200 or more, 300 or more, 400 or more, 500 or more, 600 or more, 700 or more, 800 or more, 900 or more, 1000 or more, 2000 or more, 3000 or more, 4000 or more, 5000 or more, 6000 or more, 7000 or more, 8000 or more, 9000 or more, or 10000 or more. Any of the aforementioned open-ended ranges can be combined in any manner to form closed ended ranges, such as 1-100, 500-3000, 50-500, and so forth.

In some aspects, the F⁻-containing fluid is not, or is substantially free of, at least one of a buffer, saliva, and simulated body fluid (e.g., artificial saliva). In this regard, many bioactive glasses known in the art are employed in medical applications, which necessarily employ saliva or testing with buffers or simulated body fluid such as artificial saliva or artificial plasma. However, in some aspects, a unique aspect of the disclosures herein is use of a bioactive glass to form fluorite in F⁻-containing fluid that is not, or is substantially free of, at least one of a buffer, saliva, and simulated body fluid. Examples of such F⁻-containing fluids that the disclosures herein can employ include water meant for residential uses, such as human and/or animal consumption, in which the F content is high (e.g., unsafe or at least not recommended for human and/or animal consumption, at least according to government safety standards as set forth by, for example, the U.S. Environmental Protection Agency (EPA) and/or U.S. Food and Drug Administration (FDA)). Other F⁻-containing fluids may be prepared to be high in F so as to favor production of fluorite for purposes of collecting the fluorite.

In some aspects, the methods disclosed herein are performed in a water treatment facility or a residential home. For example, in some aspects, when performed in a water treatment facility, the method treats a source of water that is intended for residential, municipal, and/or agricultural uses (e.g., human consumption, animal consumption, watering crops, and so forth). Similarly, in some aspects, when performed in a residential home (including apartments, condominiums, etc.), the method may be performed by a human by filtering tap water for consumption or gardening/landscaping purposes.

In some aspects, the fluorite forms as a precipitate or crystal phase in the F⁻-containing fluid, as a precipitate or crystal phase positioned on an outer surface of the bioactive glass, or any combination thereof. In this regard, the bioactive glass may at least partially dissolve, releasing calcium ions into the fluid and/or onto the surface of the bioactive glass, making the calcium ions available to contact F from the F⁻-containing fluid so as to precipitate and/or crystallize fluorite, either in the fluid, on a surface of the bioactive glass, or both.

In some aspects, the fluorite forms within a suitable time period upon contacting the bioactive glass with the F⁻-containing fluid. In some aspects, the time period can be determined through powder x-ray diffraction (XRD) analysis. For example, in some aspects, the fluorite forms within a time period (days) of 0.25, 0.5, 0.75, 1, 2, 3, 4, 5, 6, 7, 8, 9, or 10. In some aspects, the fluorite forms within a time period (days) of 0.25-10, 0.25-9, 0.25-8, 0.25-7, 0.25-6, 0.25-5, 0.25-4, 0.25-3, 0.25-2, 0.25-1, 0.25-0.75, 0.25-0.5, 0.5-10, 0.5-9, 0.5-8, 0.5-7, 0.5-6, 0.5-5, 0.5-4, 0.5-3, 0.5-2, 0.5-1, 0.5-0.75, 0.75-10, 0.75-9, 0.75-8, 0.75-7, 0.75-6, 0.75-5, 0.75-4, 0.75-3, 0.75-2, 0.75-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10.

In some aspects, the contacting step comprises flowing the F⁻-containing fluid through or within one or more vessels containing the bioactive glass (e.g., optionally the bioactive glass is a component of filter media, as described elsewhere herein). For example, the one or more vessels can be one or more circulation tanks, e.g., stirred circulation tanks.

In some aspects, the contacting step comprises passing the F⁻-containing fluid through filter media containing the bioactive glass. In some aspects, the filter media is contained in one or more vessels (e.g., circulation tanks). In some aspects, the filter media is disposed in a filter body comprising an inlet and an outlet, wherein the filter media is positioned between the inlet and the outlet. The filter media is described in more detail elsewhere herein.

Some aspects disclosed herein are substantially free of, or do not include, CaCO₃ (e.g., calcite), Ca(OH)₂, non-glass CaO, or any combination thereof. For example, in some aspects, the method is substantially free of, or does not include, CaCO₃ (e.g., calcite, amorphous, or a mixture thereof), Ca(OH)₂, non-glass CaO, or any combination thereof. In some aspects, the filter media is substantially free of, or does not include, CaCO₃ (e.g., calcite, amorphous, or a mixture thereof), Ca(OH)₂, non-glass CaO, or any combination thereof.

In some aspects, the bioactive glass disclosed herein comprises calcium. In some aspects, the bioactive glass disclosed herein is at least partially soluble in aqueous fluids, such as water, such that calcium ions are released from the bioactive glass upon contact with an aqueous fluid. In some aspects, the bioactive glass comprises SiO₂ and CaO. In some aspects, the bioactive glass comprises SiO₂, CaO, and P₂O₅. In some aspects, the bioactive glass comprises at least one of 25-55 wt. % SiO₂, 20-55 wt. % CaO, and 5-20 wt. % P₂O₅.

Silicon dioxide (SiO₂) may serve as the primary glass-forming oxide component of the bioactive glasses disclosed herein. SiO₂ may be included to provide high temperature stability and chemical durability. However, if too much SiO₂ is included, such as a glass containing pure SiO₂, the melting temperature is too high to be readily workable (e.g., greater than 200 poise). In addition, bioactive glasses including too much SiO₂ may suffer from decreased bioactivity. In some aspects, the bioactive glass comprises SiO₂ in an amount of at least 25 wt. %. Alternatively or additionally, in some aspects, the bioactive glass comprises SiO₂ in an amount of 55 wt. % or less. In some aspects, the bioactive glass comprises SiO₂ in an amount (wt. %) of 25-55, 25-50, 25-45, 25-40, 25-35, 25-30, 30-55, 30-50, 30-45, 30-40, 30-35, 35-55, 35-50, 35-45, 35-40, 40-55, 40-50, 40-45, 45-55, 45-50, or 50-55.

Phosphorus pentoxide (P₂O₅) may serve as a network former in bioactive glasses. Furthermore, regarding the bioactivity of the bioactive glasses herein, the liberation of phosphate ions to the surface of bioactive glasses can contribute to the formation of apatite. Apatite is an inorganic mineral in bone and teeth, and formation of apatite in a simulated body fluid, such as artificial saliva, is one criterion for a material to be bioactive, according to ASTM F1538-03 (2017), hereby incorporated by reference in its entirety for all purposes. The inclusion of phosphate ions in the bioactive glass may increase apatite formation rate and the binding capacity of the hard tissues (e.g., bone, tooth, etc.). In addition, P₂O₅ can increase the viscosity of the glass, which in turn expands the range of operating temperatures, and is therefore an advantage to the manufacture and formation of the glass. In some aspects, the bioactive glasses herein comprise P₂O₅ in an amount of at least 5 wt. %. In some aspects, the bioactive glasses herein comprise P₂O₅ in an amount of 20 wt. % of less. In some aspects, the bioactive glasses herein comprise P₂O₅ in an amount (wt. %) of 5-20, 5-15, 5-10, 10-20, 10-15, or 15-20. In some aspects, a bioactive glass herein is substantially free of, or does not contain, P₂O₅.

In some aspects, bioactive glasses disclosed herein comprise calcium, such as CaO, such that calcium ions (Ca²⁺) are released when the bioactive glass comes in contact with an aqueous fluid. In some aspects, the calcium ions come into contain with fluoride (F) in the F⁻-containing fluid to form fluorite. In some aspects, the bioactive glasses herein comprise CaO in an amount of at least 20 wt. %. In some aspects, the bioactive glasses herein comprise CaO in an amount of 55 wt. % or less. In some aspects, the bioactive glasses herein comprise CaO in an amount (wt. %) of 20-55, 20-50, 20-45, 20-40, 20-35, 20-30, 20-25, 25-55, 25-50, 25-45, 25-40, 25-35, 25-30, 30-55, 30-50, 30-45, 30-40, 30-35, 35-55, 35-50, 35-45, 35-40, 40-55, 40-50, 40-45, 45-55, 45-50, or 50-55.

In some aspects, the bioactive glasses herein comprise zirconium dioxide (ZrO₂), which may function as a network former or intermediate in precursor glasses, as well as a key oxide for improving glass thermal stability by significantly reducing glass devitrification during forming and lowering liquidus temperature. In some aspects, ZrO₂ may play a similar role as alumina (Al₂O₃) does in other bioactive glass compositions. In some aspects, the bioactive glasses herein comprise ZrO₂ in an amount of 0 wt. % or greater than 0 wt. %. In some aspects, the bioactive glasses herein comprise ZrO₂ in an amount of 10 wt. % or less. In some aspects, the bioactive glasses comprise ZrO₂ in an amount (wt. %) of 0-10, 0-9, 0-8, 0-7, 0-6, 0-5, 0-4, 0-3, 0-2, 0-1, >0-10, >0-9, >0-8, >0-7, >0-6, >0-5, >0-4, >0-3, >0-2, >0-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In some aspects, the bioactive glass is substantially free of, or does not contain, ZrO₂.

In some aspects, use of alkali oxides (Na₂O, K₂O, Li₂O, Rb₂O, or Cs₂O) in bioactive glasses can serve as aids in achieving low melting temperature and low liquidus temperatures, which can aid glass melting processes. In addition, in some aspects, the addition of alkali oxides can improve bioactivity. However, in some aspects, if the amount of alkali oxides is too high, the bioactive glasses have reduced chemical durability; in other words, in some aspects, keeping the amount of alkali oxides to a certain lower range achieves high chemical durability of the bioactive glasses. If any alkali oxides are employed, a balance should be achieved so as to provide a bioactive glass that has suitable dissolution properties so as to provide calcium ions for fluorite formation when the calcium ions come into contact with F in the F⁻-containing aqueous fluid. In some aspects, the bioactive glasses do not contain any alkali oxides (e.g., do not contain any added alkali oxides). In some aspects, the bioactive glasses are substantially free of alkali oxides. In some aspects, the bioactive glasses comprise the sum Li₂O+Na₂O+K₂O in an amount of 0 wt. % or greater than 0 wt. %. In some aspects, the bioactive glasses comprise the sum Li₂O+Na₂O+K₂O in an amount of 30 wt. % or less, 25 wt. % or less, 15 wt. % or less, or 5 wt. % or less. In some aspects, the bioactive glasses comprise the sum Li₂O+Na₂O+K₂O in an amount (wt. %) of 0-30 wt. %, such as an amount (wt. %) of 0-30, 0-25, 0-20, 0-15, 0-10, 0-5, 0-1, 1-30, 1-25, 1-20, 1-15, 1-10, 1-5, 5-30, 5-25, 5-20, 5-15, 5-10, 10-30, 10-25, 10-20, 10-15, 15-30, 15-25, 15-20, 20-30, 20-25, or 25-30. In some aspects, the bioactive glasses comprise a sum of R₂O, where R₂O is Na₂O, K₂O, Li₂O, Rb₂O, and Cs₂O, in an amount from 0-30 wt. %, such as an amount (wt. %) of 0-30, 0-25, 0-20, 0-15, 0-10, 0-5, 0-1, 1-30, 1-25, 1-20, 1-15, 1-10, 1-5, 5-30, 5-25, 5-20, 5-15, 5-10, 10-30, 10-25, 10-20, 10-15, 15-30, 15-25, 15-20, 20-30, 20-25, or 25-30. In some aspects, the bioactive glass is substantially free of, or does not contain, Li₂O, Na₂O, and K₂O. In some aspects, the bioactive glass is substantially free of, or does not contain, R₂O, where R₂O is Na₂O. K₂O, Li₂O, Rb₂O, and Cs₂O.

In some aspects, the bioactive glasses comprise Na₂O in an amount of 0 wt. % or greater than 0 wt. %. In some aspects, the bioactive glasses comprise Na₂O in an amount of 25 wt. % or less. In some aspects, the bioactive glasses comprise Na₂O in an amount (wt. %) of 0-25, 0-20, 0-15, 0-10, 0-9, 0-8, 0-7, 0-6, 0-5, 0-4, 0-3, 0-2, 0-1, 0-0.5, 0-0.1, >0-25, >0-20, >0-15, >0-10, >0-9, >0-8, >0-7. >0-6, >0-5, >0-4, >0-3, >0-2, >0-1, >0-0.5, >0-0.1, 0.1-25, 0.1-20, 0.1-15, 0.1-10, 0.1-9, 0.1-8, 0.1-7, 0.1-6, 0.1-5, 0.1-4, 0.1-3, 0.1-2, 0.1-1, 0.1-0.5, 0.5-25, 0.5-20, 0.5-15, 0.5-10, 0.5-9, 0.5-8, 0.5-7, 0.5-6, 0.5-5, 0.5-4, 0.5-3, 0.5-2, 0.5-1, 1-25, 1-20, 1-15, 1-10, 1-9, 1-8, 1-7, 1-6, 1-5, 1-4, 1-3, 1-2, 2-25, 2-20, 2-15, 2-10, 2-9, 2-8, 2-7, 2-6, 2-5, 2-4, 2-3, 2.5-25, 2.5-20, 2.5-15, 2.5-10, 2.5-9, 2.5-8, 2.5-7, 2.5-6, 2.5-5, 2.5-4, 2.5-3, 3-25, 3-20, 3-15, 3-10, 3-9, 3-8, 3-7, 3-6, 3-5, 3-4, 4-25, 4-20, 4-15, 4-10, 4-9, 4-8, 4-7, 4-6, 4-5, 5-25, 5-20, 5-15, 5-10, 5-9, 5-8, 5-7, 5-6, 6-25, 6-20, 6-15, 6-10, 6-9, 6-8, 6-7, 7-25, 7-20, 7-15, 7-10, 7-9, 7-8, 8-25, 8-20, 8-15, 8-10, 8-9, 9-25, 9-20, 9-15, 9-10, 10-25, 10-20, 10-15, 15-25, 15-20, or 20-25. In some aspects, the bioactive glass is substantially free of, or does not contain, Na₂O.

In some aspects, the bioactive glasses comprise K₂O in an amount of 0 wt. % or greater than 0 wt. %. In some aspects, the bioactive glasses comprise K₂O in an amount of 5 wt. % or less. In some aspects, the bioactive glasses comprise K₂O in an amount (wt. %) of 0-5, 0-4.5, 0-4, 0-3.5, 0-3, 0-2.5, 0-2, 0-1.5, 0-1, 0-0.5, >0-5, >0-4.5, >0-4, >0-3.5, >0-3, >0-2.5, >0-2, >0-1.5, >0-1, >0-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In some aspects, the bioactive glass is substantially free of, or does not contain, K₂O.

In some aspects, the bioactive glasses comprise Li₂O in an amount of 0 wt. % or greater than 0 wt. %. In some aspects, the bioactive glasses comprise Li₂O in an amount of 5 wt. % or less. In some aspects, the bioactive glasses comprise Li₂O in an amount (wt. %) of 0-5, 0-4.5, 0-4, 0-3.5, 0-3, 0-2.5, 0-2, 0-1.5, 0-1, 0-0.5, >0-5, >0-4.5, >0-4, >0-3.5, >0-3, >0-2.5, >0-2, >0-1.5, >0-1, >0-0.5, 0.5-5, 0.5-4.5, 0.5-4, 0.5-3.5, 0.5-3, 0.5-2.5, 0.5-2, 0.5-1.5, 0.5-1, 1-5, 1-4.5, 1-4, 1-3.5, 1-3, 1-2.5, 1-2, 1-1.5, 1.5-5, 1.5-4.5, 1.5-4, 1.5-3.5, 1.5-3, 1.5-2.5, 1.5-2, 2-5, 2-4.5, 2-4, 2-3.5, 2-3, 2-2.5, 2.5-5, 2.5-4.5, 2.5-4, 2.5-3.5, 2.5-3, 3-5, 3-4.5, 3-4, 3-3.5, 3.5-5, 3.5-4.5, 3.5-4, 4-5, 4-4.5, or 4.5-5. In some aspects, the bioactive glass is substantially free of, or does not contain, Li₂O.

In some aspects, the bioactive glasses comprise MgO. In some aspects, the inclusion of MgO can improve liquidus of the precursor glass to avoid devitrification during forming. In some aspects, the bioactive glasses comprise MgO in an amount of 0 wt. % or greater than 0 wt. %. In some aspects, the bioactive glasses comprise MgO in an amount of 10 wt. % or less. In some aspects, the bioactive glasses comprise MgO in an amount (wt. %) of 0-10, 0-9, 0-8, 0-7, 0-6, 0-5, 0-4, 0-3, 0-2, 0-1, >0-10, >0-9, >0-8, >0-7, >0-6, >0-5, >0-4, >0-3, >0-2, >0-1, 1-10, 1-9, 1-8, 1-7, 1-6, 1-5, 1-4, 1-3, 1-2, 2-10, 2-9, 2-8, 2-7, 2-6, 2-5, 2-4, 2-3, 3-10, 3-9, 3-8, 3-7, 3-6, 3-5, 3-4, 4-10, 4-9, 4-8, 4-7, 4-6, 4-5, 5-10, 5-9, 5-8, 5-7, 5-6, 6-10, 6-9, 6-8, 6-7, 7-10, 7-9, 7-8, 8-10, 8-9, or 9-10. In some aspects, the bioactive glass is substantially free of, or does not contain, MgO.

In some aspects, the bioactive glasses comprise F in an amount of 0 wt. % or greater than 0 wt. %. In some aspects, the bioactive glasses comprise F″ in an amount of 10 wt. % or less. In some aspects, the bioactive glasses comprise F in an amount (wt. %) of 0-10, 0-9, 0-8, 0-7, 0-6, 0-5, 0-4.5, 0-4, 0-3.5, 0-3, 0-2.5, 0-2, 0-1.5, 0-1, 0-0.5, 0-0.1, >0-10, >0-9, >0-8, >0-7, >0-6, >0-5, >0-4.5, >0-4, >0-3.5, >0-3, >0-2.5, >0-2, >0-1.5, >0-1, >0-0.5, >0-0.4, >0-0.3, >0-0.2, >0-0.1, >0-0.01, 0.01-10, 0.01-9, 0.01-8, 0.01-7, 0.01-6, 0.01-5, 0.01-4.5, 0.01-4, 0.01-3.5, 0.01-3, 0.01-2.5, 0.01-2, 0.01-1.5, 0.01-1, 0.01-0.5, 0.01-0.4, 0.01-0.3, 0.01-0.2, 0.01-0.1, 0.1-10, 0.1-9, 0.1-8, 0.1-7, 0.1-6, 0.1-5, 0.1-4.5, 0.1-4, 0.1-3.5, 0.1-3, 0.1-2.5, 0.1-2, 0.1-1.5, 0.1-1, 0.1-0.5, 0.1-0.4, 0.1-0.3, 0.1-0.2, 0.2-10, 0.2-9, 0.2-8, 0.2-7, 0.2-6, 0.2-5, 0.2-4.5, 0.2-4, 0.2-3.5, 0.2-3, 0.2-2.5, 0.2-2, 0.2-1.5, 0.2-1, 0.2-0.5, 0.2-0.4, 0.2-0.3, 0.3-10, 0.3-9, 0.3-8, 0.3-7, 0.3-6, 0.3-5, 0.3-4.5, 0.3-4, 0.3-3.5, 0.3-3, 0.3-2.5, 0.3-2, 0.3-1.5, 0.3-1, 0.3-1.5, 0.3-0.4, 0.4-10, 0.4-9, 0.4-8, 0.4-7, 0.4-6, 0.4-5, 0.4-4.5, 0.4-4, 0.4-3.5, 0.4-3, 0.4-2.5, 0.4-2, 0.4-1.5, 0.4-1, 0.4-0.5, 0.5-10, 0.5-9, 0.5-8, 0.5-7, 0.5-6, 0.5-5, 0.5-4.5, 0.5-4, 0.5-3.5, 0.5-3, 0.5-2.5, 0.5-2, 0.5-1.5, 0.5-1, 1-10, 1-9, 1-8, 1-7, 1-6, 1-5, 1-4.5, 1-4, 1-3.5, 1-3, 1-2.5, 1-2, 1-1.5, 1.5-10, 1.5-9, 1.5-8, 1.5-7, 1.5-6, 1.5-5, 1.5-4.5, 1.5-4, 1.5-3.5, 1.5-3, 1.5-2.5, 1.5-2, 2-10, 2-9, 2-8, 2-7, 2-6, 2-5, 2-4.5, 2-4, 2-3.5, 2-3, 2-2.5, 2.5-10, 2.5-9, 2.5-8, 2.5-7, 2.5-6, 2.5-5, 2.5-4.5, 2.5-4, 2.5-3.5, 2.5-3, 3-10, 3-9, 3-8, 3-7, 3-6, 3-5, 3-4.5, 3-4, 3-3.5, 3.5-10, 3.5-9, 3.5-8, 3.5-7, 3.5-6, 3.5-5, 3.5-4.5, 3.5-4, 4-10, 4-9, 4-8, 4-7, 4-6, 4-5, 4-4.5, 4.5-10, 4.5-9, 4.5-8, 4.5-7, 4.5-6, 4.5-5, 5-10, 5-9, 5-8, 5-7, 5-6, 6-10, 6-9, 6-8, 6-7, 7-10, 7-9, 7-8, 8-10, 8-9, or 9-10. In some aspects, the bioactive glass is substantially free of, or does not contain, F.

In some aspects, the bioactive glasses disclosed herein have any suitable average particle size. Average particle size can be measured by suitable techniques, such as dynamic light scattering (DLS), as would be known in the art. In some aspects, the bioactive glasses disclosed herein have an average particle size of at least 1 μm. In some aspects, the bioactive glasses disclosed herein have an average particle size of 5000 μm or less (i.e., 5 mm or less). In some aspects, the bioactive glasses disclosed herein have an average particle size (μm) of 1-5000, 1-4000, 1-3000, 1-2000, 1-1000, 1-800, 1-600, 1-400, 1-200, 1-100, 1-80, 1-60, 1-50, 1-40, 1-30, 1-20, 1-10, 1-8, 1-6, 1-4, 1-2, 2-5000, 2-4000, 2-3000, 2-2000, 2-1000, 2-800, 2-600, 2-400, 2-200, 2-100, 2-80, 2-60, 2-50, 2-40, 2-30, 2-20, 2-10, 2-8, 2-6, 2-4, 4-5000, 4-4000, 4-3000, 4-2000, 4-1000, 4-800, 4-600, 4-400, 4-200, 4-100, 4-80, 4-60, 4-50, 4-40, 4-30, 4-20, 4-10, 4-8, 4-6, 6-5000, 6-4000, 6-3000, 6-2000, 6-1000, 6-800, 6-600, 6-400, 6-200, 6-100, 6-80, 6-60, 6-50, 6-40, 6-30, 6-20, 6-10, 6-8, 8-5000, 8-4000, 8-3000, 8-2000, 8-1000, 8-800, 8-600, 8-400, 8-200, 8-100, 8-80, 8-60, 8-50, 8-40, 8-30, 8-20, 8-10, 10-5000, 10-4000, 10-3000, 10-2000, 10-1000, 10-800, 10-600, 10-400, 10-200, 10-100, 10-80, 10-60, 10-50, 10-40, 10-30, 10-20, 20-5000, 20-4000, 20-3000, 20-2000, 20-1000, 20-800, 20-600, 20-400, 20-200, 20-100, 20-80, 20-60, 20-50, 20-40, 20-30, 30-5000, 30-4000, 30-3000, 30-2000, 30-1000, 30-800, 30-600, 30-400, 30-200, 30-100, 30-80, 30-60, 30-50, 30-40, 40-5000, 40-4000, 40-3000, 40-2000, 40-1000, 40-800, 40-600, 40-400, 40-200, 40-100, 40-80, 40-60, 40-50, 50-5000, 50-4000, 50-3000, 50-2000, 50-1000, 50-800, 50-600, 50-400, 50-200, 50-100, 50-80, 50-60, 60-5000, 60-4000, 60-3000, 60-2000, 60-1000, 60-800, 60-600, 60-400, 60-200, 60-100, 60-80, 80-5000, 80-4000, 80-3000, 80-2000, 80-1000, 80-800, 80-600, 80-400, 80-200, 80-100, 100-5000, 100-4000, 100-3000, 100-2000, 100-1000, 100-800, 100-600, 100-400, 100-200, 200-5000, 200-4000, 200-3000, 200-2000, 200-1000, 200-800, 200-600, 200-400, 400-5000, 400-4000, 400-3000, 400-2000, 400-1000, 400-800, 400-600, 600-5000, 600-4000, 600-3000, 600-2000, 600-1000, 600-800, 800-5000, 800-4000, 800-3000, 800-2000, 800-1000, 1000-5000, 1000-4000, 1000-3000, 1000-2000, 2000-5000, 2000-4000, 2000-3000, 3000-5000, 3000-4000, or 4000-5000.

In some aspects, the method further comprises collecting the fluorite. In some aspects, the method further comprises refining the collected fluorite so as to purify the fluorite to a higher purity than prior to the refining. In some aspects, the refining results in a fluorite having a purity of at least 90 wt. %, based on total weight of the pure fluorite. In some aspects, the collecting can be any suitable collecting technique, such as gathering the bioactive glass having fluorite precipitates and/or crystallites disposed thereon, and/or filtering any fluorite precipitates and/or crystallites that are in solid form in the F⁻-containing fluid after contacting with a bioactive glass. In some aspects, the refining can comprise filtering, cycloning (e.g., hydrocycloning), or other separation techniques that can selectively separate fluorite from non-fluorite species (e.g., bioactive glass). In some aspects, the refining includes a crushing, grinding, shearing, and/or size reduction step so as to dislodge and/or separate the fluorite from other non-fluorite species (e.g., bioactive glass).

In some aspects, the refining provides a fluorite have a purity of at least 80 wt. %, at least 85 wt. %, at least 90 wt. %, at least 95 wt. %, at least 99 wt. %, or 100 wt. %.

In some aspects, disclosed in a fluorite having a purity of at least 80 wt. %, at least 85 wt. %, at least 90 wt. %, at least 95 wt. %, at least 99 wt. %, or 100 wt. %. In some aspects, the fluorite having such purity is produced by the methods disclosed herein.

In some aspects, disclosed is a bioactive glass formed by the methods disclosed herein, wherein the bioactive glass comprises a fluorite crystal phase positioned on an outer surface of the bioactive glass. In some aspects, disclosed is a bioactive glass formed by the methods disclosed herein, wherein the bioactive glass is in a composition comprising fluorite.

In some aspects, the contacting step of the method comprises a filter media comprising the bioactive glass, wherein the filter media comprises at least one of sand, gravel, charcoal, polymer particles, and ceramic particles. The filter media is the same as described elsewhere herein.

In some aspects, disclosed is a filter media comprising: a bioactive glass comprising calcium, and at least one of sand, gravel, charcoal, polymer particles, and ceramic particles. In some aspects, the filter media comprises: a bioactive glass comprising calcium, and at least one of sand, gravel, charcoal, polymer particles, ceramic particles, Ca(OH)₂, CaCO₃ (e.g., calcite, amorphous, or a mixture thereof), and non-glass CaO. In some aspects, the filter media is for forming fluorite from a F⁻-containing aqueous fluid. The bioactive glass contained in the filter media is the same bioactive glass described elsewhere herein.

In some aspects, the filter media is characterized by at least one of the following:
the sand is present and has an average particle size of 1 micron to 5 mm;
the gravel is present and has an average particle size of 1 micron to 5 mm;
the charcoal is present and has an average particle size of 1 micron to 5 mm;
the polymer particles are present and have an average particle size of 1 micron to 5 mm;
the ceramic particles are present and have an average particle size of 1 micron to 5 mm.

In some aspects, the average particle sizes of the sand, gravel, charcoal, polymer particles, and ceramic particles can independently have any suitable average particle size. Average particle size can be measured by suitable techniques, such as dynamic light scattering (DLS), as would be known in the art. In some aspects, the average particle sizes of the sand, gravel, charcoal, polymer particles, and ceramic particles can independently be at least 1 μm. In some aspects, the average particle sizes of the sand, gravel, charcoal, polymer particles, and ceramic particles can independently be 5000 μm or less (i.e., 5 mm or less). In some aspects, the average particle sizes of the sand, gravel, charcoal, polymer particles, and ceramic particles can independently be (μm) of 1-5000, 1-4000, 1-3000, 1-2000, 1-1000, 1-800, 1-600, 1-400, 1-200, 1-100, 1-80, 1-60, 1-50, 1-40, 1-30, 1-20, 1-10, 1-8, 1-6, 1-4, 1-2, 2-5000, 2-4000, 2-3000, 2-2000, 2-1000, 2-800, 2-600, 2-400, 2-200, 2-100, 2-80, 2-60, 2-50, 2-40, 2-30, 2-20, 2-10, 2-8, 2-6, 2-4, 4-5000, 4-4000, 4-3000, 4-2000, 4-1000, 4-800, 4-600, 4-400, 4-200, 4-100, 4-80, 4-60, 4-50, 4-40, 4-30, 4-20, 4-10, 4-8, 4-6, 6-5000, 6-4000, 6-3000, 6-2000, 6-1000, 6-800, 6-600, 6-400, 6-200, 6-100, 6-80, 6-60, 6-50, 6-40, 6-30, 6-20, 6-10, 6-8, 8-5000, 8-4000, 8-3000, 8-2000, 8-1000, 8-800, 8-600, 8-400, 8-200, 8-100, 8-80, 8-60, 8-50, 8-40, 8-30, 8-20, 8-10, 10-5000, 10-4000, 10-3000, 10-2000, 10-1000, 10-800, 10-600, 10-400, 10-200, 10-100, 10-80, 10-60, 10-50, 10-40, 10-30, 10-20, 20-5000, 20-4000, 20-3000, 20-2000, 20-1000, 20-800, 20-600, 20-400, 20-200, 20-100, 20-80, 20-60, 20-50, 20-40, 20-30, 30-5000, 30-4000, 30-3000, 30-2000, 30-1000, 30-800, 30-600, 30-400, 30-200, 30-100, 30-80, 30-60, 30-50, 30-40, 40-5000, 40-4000, 40-3000, 40-2000, 40-1000, 40-800, 40-600, 40-400, 40-200, 40-100, 40-80, 40-60, 40-50, 50-5000, 50-4000, 50-3000, 50-2000, 50-1000, 50-800, 50-600, 50-400, 50-200, 50-100, 50-80, 50-60, 60-5000, 60-4000, 60-3000, 60-2000, 60-1000, 60-800, 60-600, 60-400, 60-200, 60-100, 60-80, 80-5000, 80-4000, 80-3000, 80-2000, 80-1000, 80-800, 80-600, 80-400, 80-200, 80-100, 100-5000, 100-4000, 100-3000, 100-2000, 100-1000, 100-800, 100-600, 100-400, 100-200, 200-5000, 200-4000, 200-3000, 200-2000, 200-1000, 200-800, 200-600, 200-400, 400-5000, 400-4000, 400-3000, 400-2000, 400-1000, 400-800, 400-600, 600-5000, 600-4000, 600-3000, 600-2000, 600-1000, 600-800, 800-5000, 800-4000, 800-3000, 800-2000, 800-1000, 1000-5000, 1000-4000, 1000-3000, 1000-2000, 2000-5000, 2000-4000, 2000-3000, 3000-5000, 3000-4000, or 4000-5000.

In some aspects, the polymer particles of the filter media comprise polyolefin, polyacrylate, polystyrene, polyethylene terephthalate, cellulose acetate, or any combination thereof. In some aspects, examples of polyolefin include polyethylene, polypropylene, ultra-high-molecular-weight polyethylene, high-molecular-weight polyethylene, high-density polyethylene, high-density cross-linked polyethylene, cross-linked polyethylene, medium-density polyethylene, linear low-density polyethylene, low-density polyethylene, very-low-density polyethylene, chlorinated polyethylene, or any combination thereof. In some aspects, examples of polyacrylate include polyacrylate, polymethacrylate, poly(methyl) methacrylate (PMMA), or any combination thereof. In some aspects, the polymer particles of the filter media have a melting temperature (Tₘ) of greater than 25° C. (which includes, e.g., polyethylene as an example, which has a Tₘ of over 100° C.). Suitable Tₘs (° C.) are greater than 30, greater than 50, greater than 75, greater than 100, greater than 125, greater than 150, or greater than 175. Alternatively, or additionally, suitable Tₘs (C) are less than 200, less than 175, less than 150, less than 125, less than 100, less than 75, less than 50, or less than 30. Any of the aforementioned open-ended ranges for Tₘ can be combined to form a closed range, such as 25-200, 50-125, 75-175, and so forth.

In some aspects, the ceramic particles of the filter media comprise aluminum oxide, zirconium oxide, cerium-stabilized zirconium oxide, silica microspheres, or any combination thereof.

In some aspects, the aluminum oxide comprises a high amount of aluminum oxide (e.g., at least 98 wt. %, such as at least 99 wt. %, of Al₂O₃). An example composition of high aluminum oxide content aluminum oxide is Al₂O₃ 99.7 wt. %, MgO 0.15 wt. %, trace 0.15 wt. % (e.g., trace can be SiO₂, CaO, and/or FeO, etc.). In some aspects, the aluminum oxide comprises a reduced amount of aluminum oxide (e.g., at least 91 wt. %, such as at least 92 wt. %, of Al₂O₃). An example composition of reduced aluminum oxide content aluminum oxide is Al₂O₃ 92.3 wt. %, SiO₂ 2.55 wt. %, MgO 2.45 wt. %, CaO 2.10 wt. %, trace 0.6 wt. % (e.g., trace can be FeO, Na₂O, and/or K₂O, etc.).

In some aspects, the zirconium oxide comprises a high content of zirconium oxide (e.g., at least 99 wt. % ZrO₂). An example high zirconium oxide content composition is ZrO₂ 99.1 wt. %, 0.9 wt. % trace. In some aspects, the zirconium oxide is stabilized with cerium. An example composition of cerium-stabilized zirconium oxide is ZrO₂ 83 wt. %, CeO₂ 17 wt. %.

In some aspects, disclosed is a filter comprising the filter media disclosed herein. In some aspects, the filter comprises a filter body, an inlet, an outlet, and the filter media disposed in the filter body between the inlet and the outlet. In some aspects, the structure of the filter and filter media allows an F⁻-containing aqueous fluid to pass through the filter, from the inlet, through the filter media, and out the outlet. In some aspects, the inclusion of at least one of sand, gravel, charcoal, polymer particles, and ceramic particles facilitates passage of the F⁻-containing aqueous fluid through the filter media without clogging for a commercially operable amount of time prior to any need for replacement of the filter media (e.g., due to reduced flow from substantial fluorite formation on the bioactive glass).

In some aspects, disclosed is a method for making the filter disclosed herein, the method comprising inserting the filter media into the filter body. In some aspects, the method positions the filter media between an inlet and an outlet of the filter body.

In some aspects, disclosed is a method for making the filter media disclosed herein, the method comprising combining the bioactive glass disclosed herein with at least one of sand, gravel, charcoal, polymer particles, and ceramic particles.

Various aspects are contemplated herein, several of which are set forth in the paragraphs below. It is explicitly contemplated that any aspect or portion thereof can be combined to form a combination. The phrase “any other aspect herein” means any numbered aspect herein, or any aspect or aspects disclosed elsewhere herein.

Aspect 1: A method for forming fluorite from a F⁻-containing aqueous fluid, the method comprising:
contacting a bioactive glass comprising calcium with the F⁻-containing aqueous fluid; and
forming the fluorite.

Aspect 2: The method of aspect 1, or any other aspect herein, wherein the F⁻-containing fluid comprises F in an amount of at least 1 ppm by mass, based on total mass of the F⁻-containing fluid that is contacted with the bioactive glass.

Aspect 3: The method of aspect 1 or aspect 2, or any other aspect herein, wherein the F⁻-containing fluid comprises F in an amount of at least 500 ppm by mass, based on total mass of the F⁻-containing fluid that is contacted with the bioactive glass.

Aspect 4: The method of any one of aspects 1-3, or any other aspect herein, wherein the method reduces a concentration of the F in the F⁻-containing aqueous fluid to 1 ppm or less by mass, based on total mass of the F⁻-containing fluid that is contacted with the bioactive glass.

Aspect 5: The method of any one of aspects 1-4, or any other aspect herein, wherein the F⁻-containing fluid is substantially free of at least one of a buffer, saliva, and simulated body fluid.

Aspect 6: The method of any one of aspects 1-5, or any other aspect herein, wherein the method is performed in a water treatment facility or a residential home.

Aspect 7: The method of any one of aspects 1-6, or any other aspect herein, wherein the fluorite forms as a precipitate or crystal phase in the F⁻-containing fluid, as a precipitate or crystal phase positioned on an outer surface of the bioactive glass, or any combination thereof.

Aspect 8: The method of any one of aspects 1-7, or any other aspect herein, wherein at least a portion of the bioactive glass dissolves during the method to release calcium ions into the F⁻-containing fluid.

Aspect 9: The method of any one of aspects 1-8, or any other aspect herein, wherein the fluorite forms within 1 day of the contacting, as determined by XRD analysis.

Aspect 10: The method of any one of aspects 1-9, or any other aspect herein, wherein no other crystal phases besides fluorite are detected by an XRD analysis within 7 days of the contacting.

Aspect 11: The method of any one of aspects 1-10, or any other aspect herein, wherein the contacting comprises flowing the F⁻-containing fluid through or within one or more vessels containing the bioactive glass.

Aspect 12: The method of any one of aspects 1-11, or any other aspect herein, wherein the contacting comprises passing the F″-containing fluid through filter media containing the bioactive glass.

Aspect 13: The method of any one of aspects 1-12, or any other aspect herein, wherein the method is substantially free of CaCO₃, Ca(OH)₂, non-glass CaO, or any combination thereof.

Aspect 14: The method of any one of aspects 1-13, or any other aspect herein, wherein the bioactive glass comprises:
SiO₂;
CaO; and
P₂O₅.

Aspect 15: The method of any one of aspects 1-14, or any other aspect herein, wherein the bioactive glass comprises:
25-55 wt. % SiO₂;
20-55 wt. % CaO; and
5-20 wt. % P₂O₅.

Aspect 16: The method of any one of aspects 1-15, or any other aspect herein, wherein the bioactive glass comprises at least one of:
0-10 wt. % ZrO₂;
0-25 wt. % Na₂O;
0-10 wt. % MgO;
0-5 wt. % K₂O;
0-5 wt. % F; or
any combination thereof.

Aspect 17: The method of any one of aspects 1-16, or any other aspect herein, wherein the bioactive glass is substantially free of F.

Aspect 18: The method of any one of aspects 1-17, or any other aspect herein, wherein the bioactive glass has an average particle size of 1 micron to 5 mm.

Aspect 19: The method of any one of aspects 1-18, or any other aspect herein, further comprising collecting the fluorite and refining to provide a pure fluorite having a purity of at least 90 wt. %, based on total weight of the pure fluorite.

Aspect 20: The method of any one of aspects 1-19, or any other aspect herein, wherein the contacting comprises a filter media comprising the bioactive glass, wherein the filter media comprises at least one of sand, gravel, charcoal, polymer particles, and ceramic particles.

Aspect 21: A bioactive glass formed by the method of any one of aspects 1-20, or any other aspect herein, wherein the bioactive glass comprises a fluorite crystal phase positioned on an outer surface of the bioactive glass.

Aspect 22: A filter media for forming fluorite from a F⁻-containing aqueous fluid, the filter media comprising:
a bioactive glass comprising calcium; and
at least one of sand, gravel, charcoal, polymer particles, and ceramic particles.

Aspect 23: The filter media of aspect 22, or any other aspect herein, wherein the bioactive glass comprises:
SiO₂;
CaO; and
P₂O₅.

Aspect 24: The filter media of aspect 22 or aspect 23, or any other aspect herein, wherein the bioactive glass comprises:
25-55 wt. % SiO₂;
20-45 wt. % CaO; and
5-20 wt. % P₂O₅.

Aspect 25: The filter media of any one of aspects 22-24, or any other aspect herein, wherein the bioactive glass comprises:
0-10 wt. % ZrO₂;
0-25 wt. % Na₂O;
0-5 wt. % MgO;
0-5 wt. % K₂O;
0-5 wt. % F; or
any combination thereof.

Aspect 26: The filter media of any one of aspects 22-25, or any other aspect herein, comprising a fluorite crystal phase positioned on an outer surface of the bioactive glass.

Aspect 27: The filter media of any one of aspects 22-26, or any other aspect herein, wherein the bioactive glass is substantially free of F.

Aspect 28: The filter media of any one of aspects 22-27, or any other aspect herein, wherein the bioactive glass has a particle size of 1 micron to 5 mm.

Aspect 29: The filter media of any one of aspects 22-28, or any other aspect herein, wherein at least one of the following is satisfied:
the sand is present and has an average particle size of 1 micron to 5 mm;
the gravel is present and has an average particle size of 1 micron to 5 mm;
the charcoal is present and has an average particle size of 1 micron to 5 mm;
the polymer particles are present and have an average particle size of 1 micron to 5 mm;
the ceramic particles are present and have an average particle size of 1 micron to 5 mm.

Aspect 30: The filter media of any one of aspects 22-29, or any other aspect herein, wherein the polymer particles are present and comprise polyolefin, polyacrylate, polystyrene, polyethylene terephthalate, cellulose acetate, or any combination thereof.

Aspect 31: The filter media of any one of aspects 22-30, or any other aspect herein, wherein the ceramic particles are present and comprise aluminum oxide, zirconium oxide, cerium-stabilized zirconium oxide, silica microspheres, or any combination thereof.

Aspect 32: A filter comprising the filter media of any one of aspects 22-31 or any other aspect herein.

Aspect 33: The filter of aspect 32, or any other aspect herein, comprising a filter body, an inlet, an outlet, and the filter media disposed in the filter body between the inlet and the outlet.

Aspect 34: A method for making the filter of aspect 32 or aspect 33, or any other aspect herein, comprising inserting the filter media into the filter body.

Aspect 35: A method for making the filter media of any one of aspects 22-34, or any other aspect herein, comprising combining the bioactive glass and at least one of sand, gravel, charcoal, polymer particles, and ceramic particles.

Aspect 36: A combination of any two or more preceding aspects or any portion(s) thereof.

### Examples

The following examples illustrate non-limiting aspects of the disclosure and are not intended to be limiting on the scope of the disclosure or claims.

This example demonstrates forming fluorite on bioactive glass by immersing in a F⁻-containing aqueous fluid.

Glass compositions having the compositions and densities shown in Table 1 were prepared by melting at a temperature below 1400° C. (e.g., below 1200° C.). This low melting temperature makes it possible to melt in a relatively small commercial glass tank if desired.

TABLE 1

| (wt. %) | *45S5 | 1 | 2 | 3 | 4 | 5 | 6 | 7 | 8 | 9 |
|---|---|---|---|---|---|---|---|---|---|---|
| SiO₂ | 45.0 | 29.5 | 53.6 | 47.6 | 33.45 | 33.3 | 31.4 | 33.4 | 30.4 | 31.4 |
| CaO | 24.5 | 42.5 | 33.1 | 31.8 | 42.5 | 42.5 | 42.5 | 42.5 | 42.5 | 42.5 |
| P₂O₅ | 6.0 | 19.5 | 5.8 | 5.6 | 15.5 | 15.5 | 17.5 | 15.5 | 18.5 | 17.5 |
| ZrO₂ | 0.0 | 4.0 | 0.0 | 7.7 | 4 | 4 | 4 | 4 | 4 | 4 |
| Na₂O | 24.5 | 0.0 | 1.6 | 1.6 | 0 | 0 | 0 | 0 | 0 | 0 |
| MgO | 0.0 | 4.5 | 1.8 | 1.7 | 4.5 | 4.5 | 4.5 | 4.5 | 4.5 | 4.5 |
| K₂O | 0.0 | 0.0 | 4.0 | 3.9 | 0 | 0 | 0 | 0 | 0 | 0 |
| F⁻ | 0 | 0 | 0 | 0 | 0.05 | 0.2 | 0.1 | 0.1 | 0.1 | 0.1 |
| **Density | 2.71 | 2.99 | 2.75 | 2.87 | — | — | — | — | — | — |

| (wt. %) | 10 | 11 | 12 | 13 | 14 | 15 |
|---|---|---|---|---|---|---|
| SiO₂ | 33.4 | 35.4 | 42 | 41 | 40 | 38 |
| CaO | 42.5 | 42.5 | 42.5 | 42.5 | 42.5 | 42.5 |
| P₂O₅ | 15.5 | 13.5 | 6 | 6 | 8 | 10 |
| ZrO₂ | 4 | 4 | 4 | 4 | 4 | 4 |
| Na₂O | 0 | 0 | 0 | 0 | 0 | 0 |
| MgO | 4.5 | 4.5 | 4.5 | 4.5 | 4.5 | 4.5 |
| K₂O | 0 | 0 | 0 | 0 | 0 | 0 |
| F⁻ | 0.1 | 0.1 | 1 | 2 | 1 | 1 |
| **Density | — | — | — | — | — | — |

*45S5 Bioglass ® is sold by Haleon under the Sensodyne ® brand featuring NovaMin ® technology
** g/cm³

45S5 and compositions #1-#3 shown in Table 1 were immersed in solutions containing about 9000 ppm of fluoride, present as dissolved sodium fluoride in a 0.05 mol/L tris(hydroxy)aminomethane buffer solution, adjusted to pH_{RT} of 7.9 with hydrochloric acid. The solution contained, in water, 2.02 wt. % NaF, 0.61 wt. % tris(hydroxy)aminomethane, and 0.18 wt. % HCl. For each experiment, 2.0 g of bioactive glass was submerged in these solutions at 37° C. for up to 7 days. Each glass was ground to <10 microns particle size prior to immersion. The results are depicted in FIGS. 1-4.

FIGS. 1-2 depict XRD spectra of 45S5 and example compositions #1-#3 after submersion in fluoride solution for up to 7 days. Fluorite was detected for all glasses after 7 days of submersion following powder recovery (FIG. 1). FIG. 2 depicts composition #3 immersed for 1, 4, and 7 days, highlighting that fluorite forms rapidly (within 1 d) upon exposure of an example bioactive glass to a F⁻-containing aqueous fluid.

FIGS. 3-4 depict SEM images of particles of glass composition #3 after submersion in the fluoride solution for 7 days, at 10 kX (FIG. 3) and 25 kX (FIG. 4) magnifications. The images show the nanometer-size fluorite precipitates or crystallites forming on the surface of the glass particles, as identified with XRD.

It will be appreciated that the various disclosed aspects or embodiments may involve particular features, elements or steps that are described in connection with that particular aspect or embodiment. It will also be appreciated that a particular feature, element, or step, although described in relation to one particular aspect or embodiment, may be interchanged or combined with alternate aspects or embodiments in various non-illustrated combinations or permutations.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

While various features, elements, or steps of particular aspects or embodiments may be disclosed using the transitional phrase “comprising.” it is to be understood that alternative aspects or embodiments, including those that may be described using the transitional phrases “consisting of” or “consisting essentially of,” are implied. Thus, for example, implied alternative aspects or embodiments to a device that comprises A+B+C include aspects or embodiments where a device consists of A+B+C and aspects or embodiments where a device consists essentially of A+B+C.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Unless otherwise specified, all compositions are expressed in terms of as-batched weight percent (wt. %). As will be understood by those having ordinary skill in the art, various melt constituents (e.g., silicon, alkali- or alkaline-based, boron, etc.) may be subject to different levels of volatilization (e.g., as a function of vapor pressure, melt time and/or melt temperature) during melting of the constituents. As such, the as-batched weight percent values used in relation to such constituents are intended to encompass values within +0.5 wt. % of these constituents in final, as-melted articles. With the forgoing in mind, substantial compositional equivalence between final articles and as-batched compositions is expected.

It will be apparent to those ordinarily skilled in the art that various modifications and variations can be made to the present disclosure without departing from the spirit and scope of the disclosure. Since modifications combinations, sub-combinations, and variations of the disclosed embodiments incorporating the spirit and substance of the disclosure may occur to persons ordinarily skilled in the art, the disclosure should be construed to include everything within the scope of the appended claims and their equivalents.

What is claimed is:

1. A method for forming fluorite from a F⁻-containing aqueous fluid, the method comprising:
contacting a bioactive glass comprising calcium with the F⁻-containing aqueous fluid; and
forming the fluorite.

2. The method of claim 1, wherein the F⁻-containing fluid comprises F in an amount of at least 500 ppm by mass, based on total mass of the F⁻-containing fluid that is contacted with the bioactive glass.

3. The method of claim 1, wherein the method reduces a concentration of the F⁻ in the F⁻-containing aqueous fluid to 1 ppm or less by mass, based on total mass of the F⁻-containing fluid that is contacted with the bioactive glass.

4. The method of claim 1, wherein the F⁻-containing fluid is substantially free of at least one of a buffer, saliva, and simulated body fluid.

5. The method of claim 1, wherein the fluorite forms as a precipitate or crystal phase in the F⁻-containing fluid, as a precipitate or crystal phase positioned on an outer surface of the bioactive glass, or any combination thereof.

6. The method of claim 1, wherein at least a portion of the bioactive glass dissolves during the method to release calcium ions into the F⁻-containing fluid.

7. The method of claim 1, wherein the fluorite forms within 1 day of the contacting, as determined by XRD analysis.

8. The method of claim 1, wherein no other crystal phases besides fluorite are detected by an XRD analysis within 7 days of the contacting.

9. The method of claim 1, wherein the contacting comprises flowing the F⁻-containing fluid through or within one or more vessels containing the bioactive glass.

10. The method of claim 1, wherein the contacting comprises passing the F⁻-containing fluid through filter media containing the bioactive glass.

11. The method of claim 1, wherein the method is substantially free of CaCO₃, Ca(OH)₂, non-glass CaO, or any combination thereof.

12. The method of claim 1, wherein the bioactive glass comprises:
SiO₂;
CaO; and
P₂O₅.

13. The method of claim 1, wherein the bioactive glass comprises:
25-55 wt. % SiO₂;
20-55 wt. % CaO; and
5-20 wt. % P₂O₅;
and optionally one or more of:
0-10 wt. % ZrO₂;
0-25 wt. % Na₂O;
0-10 wt. % MgO;
0-5 wt. % K₂O;
0-5 wt. % F; or
any combination thereof.

14. The method of claim 1, wherein the bioactive glass is substantially free of F⁻.

15. The method of claim 1, further comprising collecting the fluorite and refining to provide a pure fluorite having a purity of at least 90 wt. %, based on total weight of the pure fluorite.

16. A filter media for forming fluorite from a F⁻-containing aqueous fluid, the filter media comprising:
a bioactive glass comprising calcium; and
at least one of sand, gravel, charcoal, polymer particles, and ceramic particles.

17. The filter media of claim 16, wherein the bioactive glass comprises:
SiO₂;
CaO; and
P₂O₅.

18. The filter media of claim 16, wherein the bioactive glass comprises:
25-55 wt. % SiO₂;
20-45 wt. % CaO; and
5-20 wt. % P₂O₅;
and optionally one or more of:
0-10 wt. % ZrO₂;
0-25 wt. % Na₂O;
0-5 wt. % MgO;
0-5 wt. % K₂O;
0-5 wt. % F; or
any combination thereof.

19. The filter media of claim 16, wherein the bioactive glass is substantially free of F⁻.

20. The filter media of claim 16, wherein at least one of the following is satisfied:
the sand is present and has an average particle size of 1 micron to 5 mm;
the gravel is present and has an average particle size of 1 micron to 5 mm;
the charcoal is present and has an average particle size of 1 micron to 5 mm;
the polymer particles are present and have an average particle size of 1 micron to 5 mm;
the ceramic particles are present and have an average particle size of 1 micron to 5 mm.
